(19) United States
(12) Patent Application Publication
(10) Pub. No.: US 2026/0232128 A1
(43) Pub. Date: Aug. 13, 2026

(54) Juicing Device

(71) Applicant: Sofia Samaras, Northcote (AU)

(72) Inventor: Sofia Samaras, Northcote (AU)

(21) Appl. No.: 19/051,788

(22) Filed: Feb. 12, 2025

(51) Int. Cl. A47J 19/02; F25D 23/04

(52) U.S. Cl. CPC A47J 19/025; F25D 23/04; F25D 2323/02

(57) ABSTRACT

A juicing device for preparing fresh juice and dispensing the fresh juice with a dispenser positioned on an external surface of a refrigerator door includes a refrigerator having a refrigerator door. A hopper is coupled to the refrigerator door. The hopper has a hopper inner volume for releasably retaining a juicing material. A juice extractor is coupled to the hopper and to the refrigerator door. The juice extractor generally includes a pair of rollers. A roller motor is actuatable to rotate the pair of rollers in opposing directions to direct the juicing material downwardly between the pair of rollers and to extract a juice from the juicing material. The juice flows from the juice extractor into a container. A nozzle is fluidly coupled to the container. A pump is actuatable to direct the juice from the container outwardly through the nozzle.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to juicers and more particularly pertains to a new juicer for preparing fresh juice and dispensing the fresh juice with a dispenser positioned on an external surface of a refrigerator door.

### (2) Description of Related Art Including Information Disclosed Under 37 CFR 1.97 and 1.98.

The prior art relates to juicers. Juicers are a popular kitchen appliance because of the expense of purchasing a freshly squeezed juice from a store or restaurant. However, juicers are often large, bulky, and difficult to clean. Thus, even when a person owns a juicer, they may avoid using the juicer. There is a need in the art for a more convenient juicer, which can be used to make freshly squeezed juices at home. Ideally, such a device would be integrated into a refrigerator, so that the user does not need a separate appliance that takes up space on the counter or in the kitchen cupboard.

### BRIEF SUMMARY OF THE INVENTION

An embodiment of the disclosure meets the needs presented above by generally comprising a refrigerator having a refrigerator door. A hopper is coupled to the refrigerator door. The hopper has a hopper inner volume. The hopper inner volume releasably retains a juicing material. A processor is positioned within the refrigerator door. A juice extractor is coupled to the hopper wherein the juice extractor is configured to receive the juicing material from the hopper. The juice extractor is coupled to the refrigerator door.

The juice extractor generally includes a pair of rollers. Each roller of the pair of rollers is rotatable. A roller motor is electrically coupled to the processor. The roller motor is operably coupled to each roller of the pair of rollers wherein the roller motor is actuatable to rotate the pair of rollers of the pair of rollers. The roller motor rotates the pair of rollers in opposing directions wherein the pair of rollers is configured to direct the juicing material downwardly between the pair of rollers when the juicing material contacts the pair of rollers. The pair of rollers are spaced from each other by a distance that is configured to complement a size of the juicing material wherein the pair of rollers is configured to press the juicing material between the pair of rollers when the juicing material is directed downwardly between the pair of rollers to extract a juice from the juicing material.

A container is fluidly coupled to the juice extractor wherein the juice flows from the juice extractor into the container. A juice dispenser alcove extends into the refrigerator door. The juice dispenser alcove is configured to receive a glass wherein the juice dispenser alcove is configured to facilitate filling the glass with the juice. A nozzle is fluidly coupled to the container. The nozzle extends into the juice dispenser alcove wherein the nozzle is configured to be positioned above the glass to release the juice into the glass when the glass is positioned in the juice dispenser alcove. A pump is electrically coupled to the processor. The pump is coupled to the container and the nozzle. The pump is actuatable to direct the juice from the container outwardly through the nozzle.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front view of a juicing device according to an embodiment of the disclosure.

FIG. 2 is a detail view of an embodiment of the disclosure.

FIG. 3 is a detail view of an embodiment of the disclosure.

FIG. 4 is a detail view of an embodiment of the disclosure.

FIG. 5 is a detail view of an embodiment of the disclosure.

FIG. 6 is a side view of an embodiment of the disclosure.

FIG. 7 is a detail view of an embodiment of the disclosure.

FIG. 8 is a detail view of an embodiment of the disclosure.

FIG. 9 is a side view of an embodiment of the disclosure.

FIG. 10 is a detail view of an embodiment of the disclosure.

FIG. 11 is a front view of an embodiment of the disclosure.

FIG. 12 is a block diagram view of an embodiment of the disclosure.

### DETAILED DESCRIPTION OF THE INVENTION

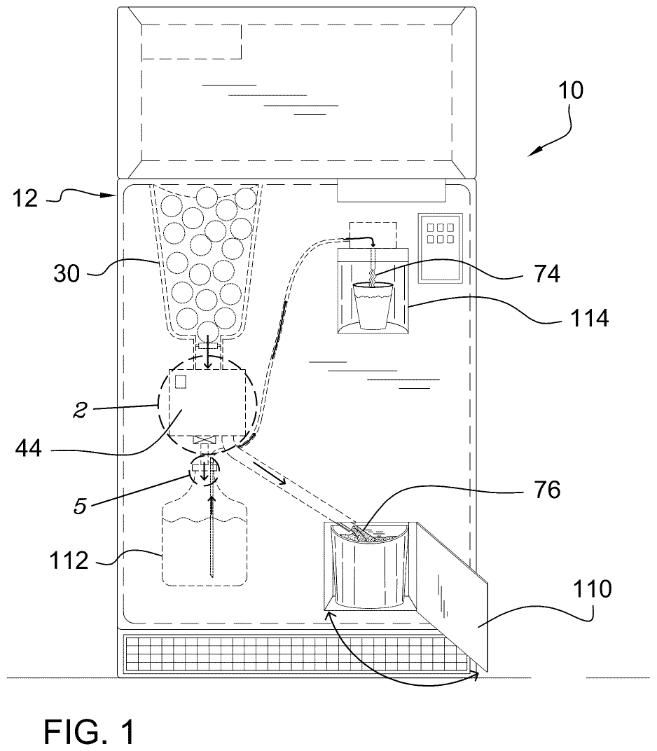

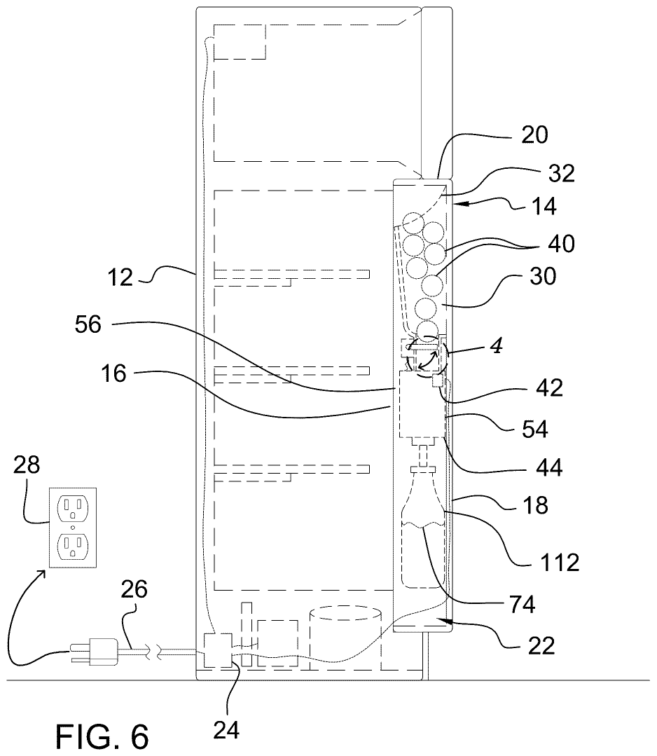

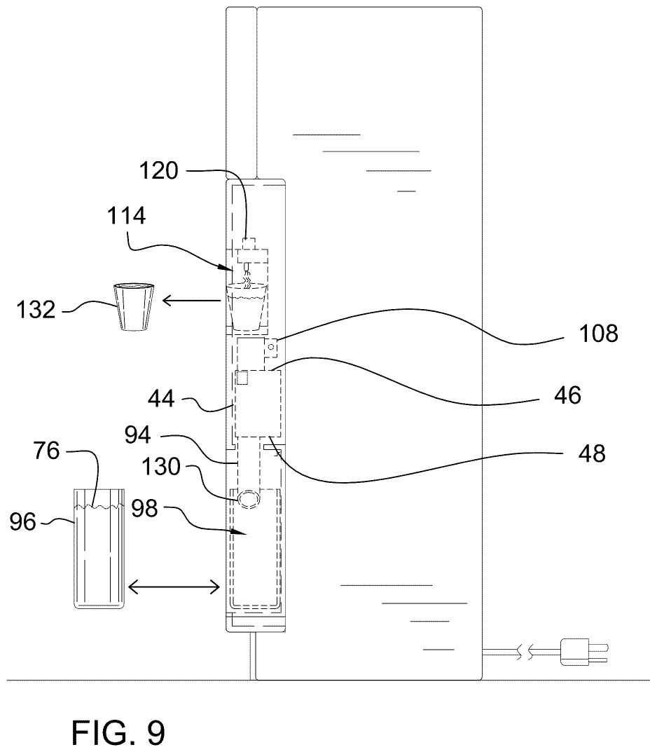

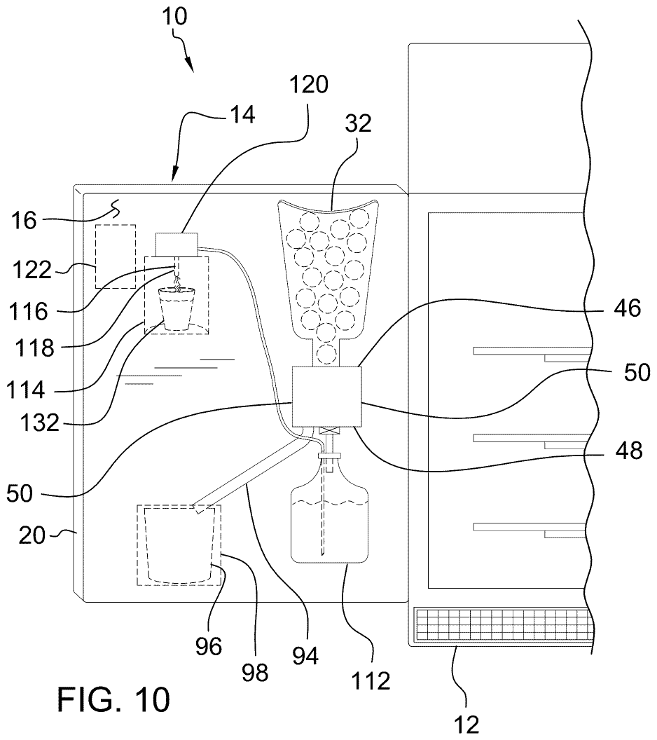

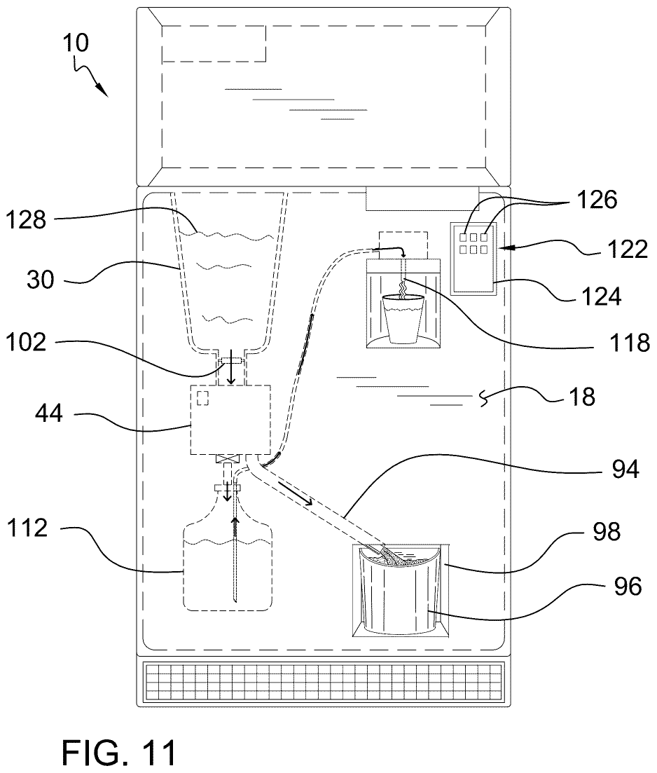

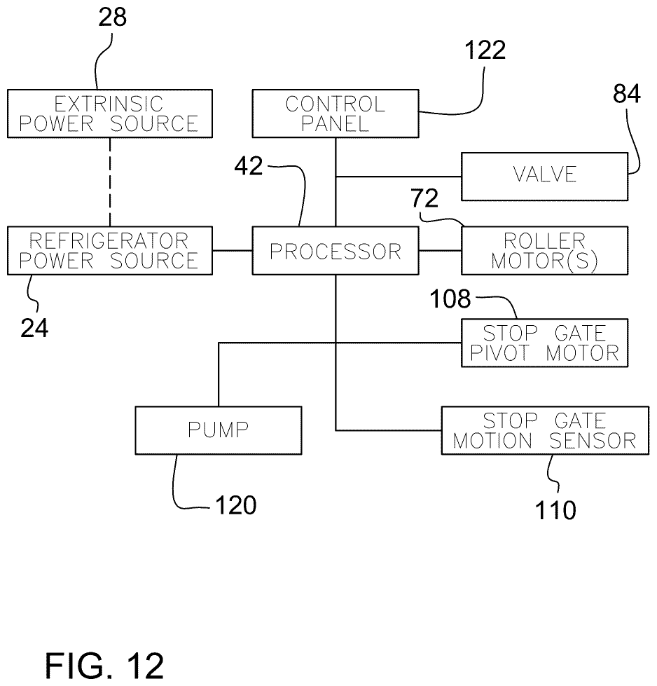

With reference now to the drawings, and in particular to FIGS. 1 through 12 thereof, a new juicer embodying the principles and concepts of an embodiment of the disclosure and generally designated by the reference numeral 10 will be described.

As best illustrated in FIGS. 1 through 12, the juicing device 10 generally comprises a refrigerator 12 having a refrigerator door 14. The refrigerator door 14 generally has an inner wall 16, an outer wall 18, and a peripheral wall 20 that is coupled to and extends between the inner wall 16 and the outer wall 18 to define a refrigerator door interior space 22.

A refrigerator power source, such as a transformer 24, may be positioned within the refrigerator 12. The transformer 24 is electrically coupled to a power input 26. For example, the power input 26 may be a power cord extending from the refrigerator 12. The power input 26 is configured to be electrically couplable to an extrinsic power source 28 wherein the power input 26 is configured to transfer power from the extrinsic power source 28 to the transformer 24.

A hopper 30 is coupled to the refrigerator door 14. The hopper 30 may be positioned in the refrigerator door interior space 22. The hopper 30 generally has a hopper top end 32, a hopper bottom end 34, and a hopper lateral wall 36 that is coupled to and extends between the hopper top end 32 and the hopper bottom end 34 to define a hopper inner volume 38. The hopper inner volume 38 releasably retains a juicing material 40, such as fruit, vegetables, herbs, spices, and other ingredients used to make fresh juices. As shown in the figures, the juicing material 40 may comprise oranges used to make fresh orange juice, although other ingredients are also contemplated. The hopper top end 32 is generally open to facilitate access to the hopper inner volume 38 and wherein the hopper top end 32 is configured to facilitate a user in adding the juicing material 40 to the hopper inner volume 38.

A processor 42 may be electrically coupled to the transformer 24. The processor 42 may be positioned in the refrigerator door interior space 22.

A juice extractor 44 is coupled to the hopper 30 wherein the juice extractor 44 is configured to receive the juicing material 40 from the hopper inner volume 38. The juice extractor 44 is generally positioned in the refrigerator door interior space 22. The juice extractor 44 may include a juice extractor top end 46 that is positioned proximate to the hopper 30. A juice extractor bottom end 48 may be spaced from the juice extractor top end 46. A juice extractor first lateral side 50 may be coupled to and extend between the juice extractor top end 46 and the juice extractor bottom end 48. A juice extractor second lateral side 52 may be spaced from the juice extractor first lateral side 50. The juice extractor second lateral side 52 may be coupled to and extend between the juice extractor top end 46 and the juice extractor bottom end 48. A juice extractor front side 54 may be coupled to and extend between the juice extractor top end 46 and the juice extractor bottom end 48. The juice extractor front side 54 may be perpendicular to each of the juice extractor first lateral side 50 and the juice extractor second lateral side 52. A juice extractor back side 56 may be spaced from the juice extractor front side 54. The juice extractor back side 56 may be parallel to the juice extractor front side 54.

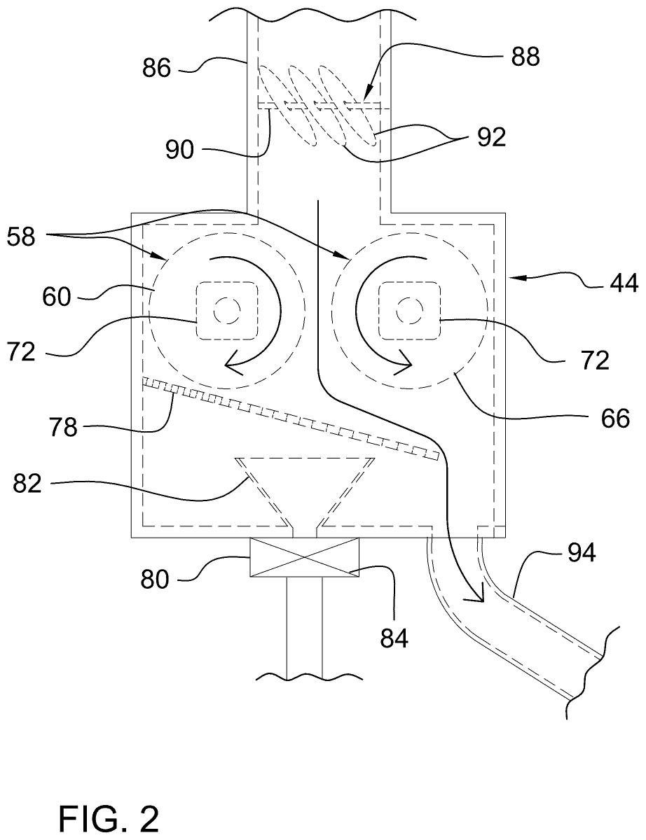

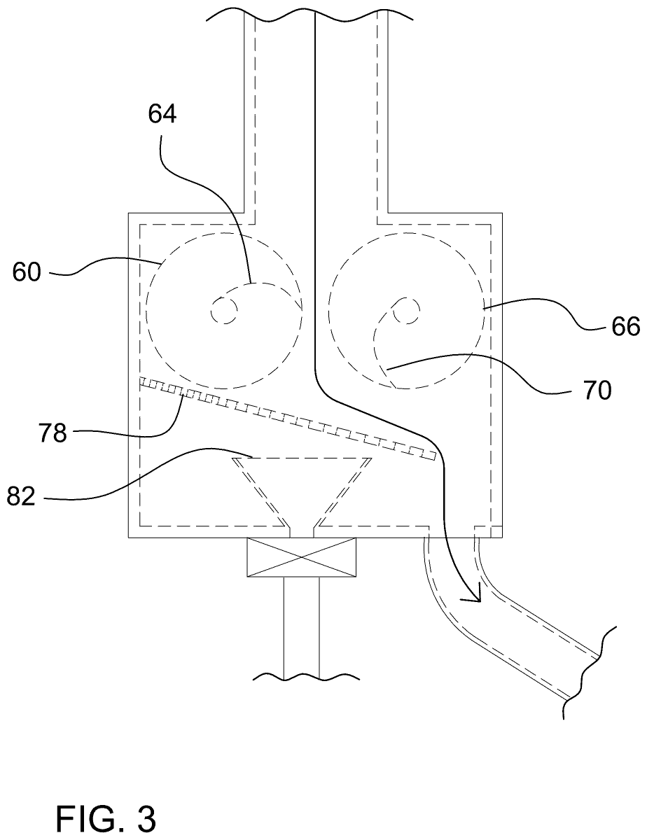

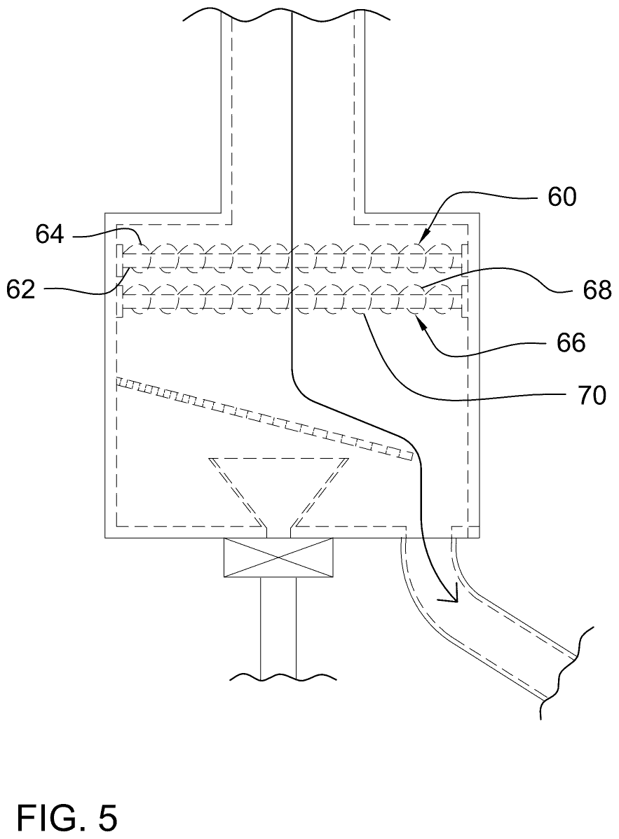

A pair of rollers 58 may be positioned proximate to the juice extractor top end 46. Each roller of the pair of rollers 58 is rotatable. For example, the pair of rollers 58 may extend between the juice extractor front side 54 and the juice extractor back side 56 wherein the pair of rollers 58 is parallel to the juice extractor first lateral side 50 and the juice extractor second lateral side 52. FIGS. 2 and 3 provide examples of such embodiments. Alternatively, as shown in FIG. 5, the pair of rollers 58 may extend from the juice extractor first lateral side 50 to the juice extractor second lateral side 52 wherein the pair of rollers 58 is parallel to the juice extractor front side 54.

The pair of rollers 58 may include a first roller 60 and a second roller 66. As shown in FIGS. 2 and 3, the first roller 60 may be positioned proximate to the juice extractor first lateral side 50. In such embodiments, the second roller 66 may be positioned next to the first roller 60, for example proximate to the juice extractor second lateral side 52. In embodiments according to FIG. 5, the second roller 66 may be positioned beneath the first roller 60.

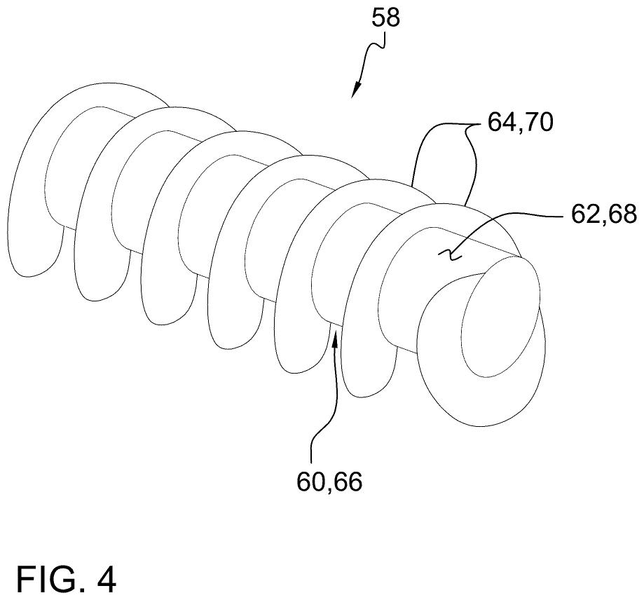

The first roller 60 may include a first roller outer surface 62. A first roller blade 64 may be coupled to and extend outwardly from the first roller outer surface 62. The first roller blade 64 is sharpened wherein the first roller blade 64 is configured to slice the juicing material 40 when the juicing material 40 contacts the first roller 60. As shown in FIGS. 4 and 5, the first roller blade 64 may be coextensive with a length of the first roller 60.

The second roller 66 may include a second roller outer surface 68. A second roller blade 70 may be coupled to and extend outwardly from the second roller outer surface 68. The second roller blade 70 is sharpened wherein the second roller blade 70 is configured to slice the juicing material 40 when the juicing material 40 contacts the second roller 66. As shown in FIGS. 4 and 5, the second roller blade 70 may be coextensive with a length of the second roller 66.

A roller motor 72 may be electrically coupled to the processor 42. The roller motor 72 is operably coupled to each roller of the pair of rollers 58 wherein the roller motor 72 is actuatable to rotate each roller of the pair of rollers 58. For example, the roller motor 72 may include a first roller motor operably coupled to the first roller 60 and a second roller motor operably coupled to the second roller 66. Alternatively, the roller motor 72 may comprise a single motor that is operably coupled to both the first roller 60 and the second roller 66.

The roller motor 72 generally rotates the pair of rollers 58 in opposing directions wherein the pair of rollers 58 is configured to direct the juicing material 40 downwardly between the pair of rollers 58 when the juicing material 40 contacts the pair of rollers 58. For example, the roller motor 72 may rotate the first roller 60 in a first direction, such as clockwise, and the roller motor 72 may rotate the second roller 66 in a second direction, such as counterclockwise.

The pair of rollers 58 are generally spaced from each other by a distance that is configured to complement a size of the juicing material 40 wherein the pair of rollers 58 is configured to press the juicing material 40 between the pair of rollers 58 when the juicing material 40 is directed downwardly between the pair of rollers 58 to extract a juice 74 from the juicing material 40. For example, the distance between the pair of rollers 58 may be smaller than a size of the juicing material 40 so that the pair of rollers 58 squeeze the juicing material 40 to extract the juice 74 as the juicing material 40 moves between the pair of rollers 58. Because the roller motor 72 rotates the pair of rollers 58 in opposing directions, the pair of rollers 58 may be configured to urge a solid waste 76 from the juicing material 40 downward toward the juice extractor bottom end 48 after the juicing material 40 contacts each roller of the pair of rollers 58. The solid waste 76 generally comprises the flesh, skins, seeds, or other matter from the juicing material 40 that remains after the juice 74 is extracted. For example, when the juicing material 40 includes the oranges shown in the Figures, the solid waste 76 may include the orange peels, seeds, and central cores of the oranges.

A screen 78 may be positioned beneath the pair of rollers 58. For example, the screen 78 may be coupled to the juice extractor first lateral side 50. The screen 78 may be angled to extend outwardly from the juice extractor first lateral side 50 toward the juice extractor second lateral side 52 and to extend downwardly toward the juice extractor bottom end 48. When the screen 78 is thusly angled, the screen 78 may direct the solid waste 76 toward a junction between the juice extractor bottom end 48 and the juice extractor second lateral side 52 as the solid waste 76 falls from between the pair of rollers 58.

The screen 78 is generally foraminous wherein the screen 78 is configured to facilitate the juice 74 in draining through the screen 78. The screen 78 may separate the juice 74 from the solid waste 76 because the juice 74 can drain through the foramen in the screen 78 while the screen 78 configured to inhibit the solid waste 76 from draining through the screen 78. The screen 78 may be spaced from the juice extractor second lateral side 52 wherein the screen 78 is configured to facilitate the solid waste 76 in moving toward a junction between the juice extractor bottom end 48 and the juice extractor second lateral side 52.

A juice drain 80 may extend through the juice extractor bottom end 48 for releasing the juice 74 from the juice extractor 44. For example, the juice drain 80 may be centrally positioned between the juice extractor first lateral side 50 and the juice extractor second lateral side 52. Alternatively, the juice drain 80 may be positioned proximate to the juice extractor first lateral side 50.

A funnel 82 may be coupled to the juice drain 80. The funnel 82 may extend upwardly from the juice drain 80 toward the screen 78. The funnel 82 is configured to direct the juice 74 into the juice drain 80 as the juice 74 drains through the screen 78.

A valve 84 may be coupled to the juice drain 80. The valve 84 is generally movable between a valve open position and a valve closed position. The juice 74 flows outwardly through the juice drain 80 when the valve 84 is in the valve open position. The juice 74 is inhibited from flowing outwardly through the juice drain 80 when the valve 84 is in the valve closed position. The valve 84 may be electrically coupled to the processor 42 wherein the processor 42 is configured to move the valve 84 between the valve open position and the valve closed position.

A channel 86 may couple the hopper 30 to the juice extractor 44. For example, the channel 86 may extend downwardly from the hopper bottom end 34 to the juice extractor top end 46. The juicing material 40 may move through the channel 86 from the hopper 30 to the juice extractor 44.

A cutting tool 88 may be positioned above the pair of rollers 58. For example, the cutting tool 88 may be positioned in the channel 86. The cutting tool 88 may extend across the channel 86 wherein the cutting tool 88 is configured to slice the juicing material 40 as the juicing material 40 moves from the hopper inner volume 38 to the juice extractor 44. Slicing the juicing material 40 may facilitate the pair of rollers 58 in extracting the juice 74 when the pair of rollers 58 squeezes and presses the juicing material 40.

As shown in FIG. 2, the cutting tool 88 may include a rod 90 that is coupled to and extends across the channel 86. The rod 90 may be perpendicular to the channel 86. A plurality of disks 92 may be coupled to the rod 90. The plurality of disks 92 are generally sharpened wherein the plurality of disks 92 is configured to slice the juicing material 40 before the juicing material 40 reaches the pair of rollers 58, whereby the cutting tool 88 is configured to facilitate the juice extractor 44 in extracting the juice 74 from the juicing material 40.

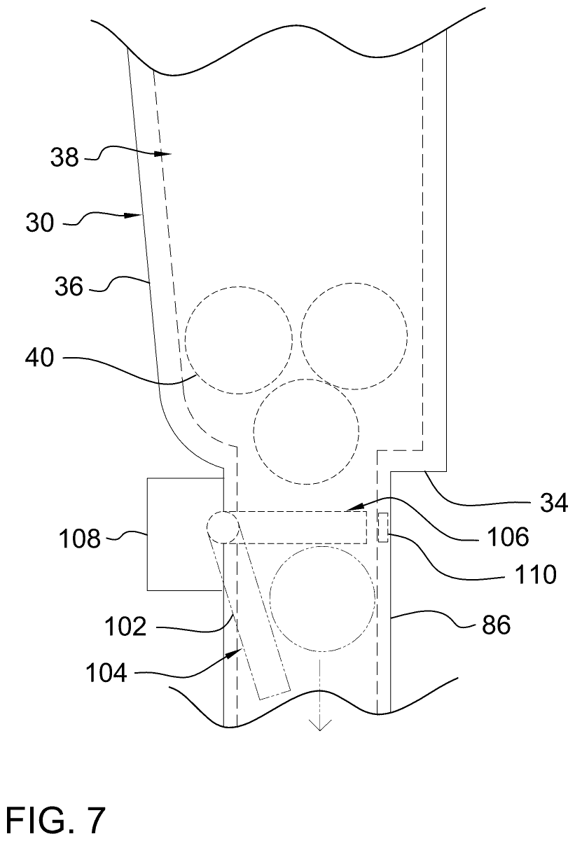

A gate 102 may be coupled to the channel 86. The gate 102 is generally positioned adjacent to the hopper bottom end 34 and may be positioned above the cutting tool 88. The gate 102 may be pivotably coupled to the channel 86. For example, the gate 102 may be pivotable between a gate open position 104 and a gate closed position 106. The gate 102 may extend downwardly along the channel 86 when the gate 102 is in the gate open position 104 wherein the gate 102 is configured to facilitate the juicing material 40 in exiting the hopper inner volume 38 through the channel 86. The gate 102 may extend across the channel 86 when the gate 102 is in the gate closed position 106 wherein the gate 102 is configured to inhibit the juicing material 40 from exiting the hopper inner volume 38 through the channel 86. FIG. 7 provides an exemplary embodiment of the gate 102, showing the gate open position 104 and the gate closed position 106.

A gate motor 108 may be electrically coupled to the processor 42. The gate motor 108 is operably coupled to the gate 102. The gate motor 108 is actuatable to selectively pivot the gate 102 between the gate open position 104 and the gate closed position 106.

A motion sensor 110 may be coupled to the channel 86. The motion sensor 110 may be electrically coupled to the processor 42. The motion sensor 110 is generally positioned adjacent to the gate 102 wherein the motion sensor 110 is configured to detect movement of the juicing material 40 through the channel 86. When the gate 102 is in the gate open position 104, the processor 42 may actuate the gate motor 108 to pivot the gate 102 to the gate closed position 106 when a threshold amount of the juicing material 40 has passed from the hopper 30 into the channel 86. The threshold amount of the juicing material 40 may be configured to correspond to a particular volume of the juice 74 wherein the motion sensor 110 is configured to facilitate the user in obtaining the particular volume of the juice 74. The threshold amount of the juicing material 40 may also be configured to correspond to the rate at which the juicing material 40 which can move through the juice extractor 44, wherein the motion sensor 110 is configured to inhibit the hopper 30 from overfilling the juice extractor 44.

A solid waste exit tube 94 may be fluidly coupled to the juice extractor 44. The solid waste exit tube 94 is configured to facilitate removal of the solid waste 76 from the juice extractor 44. The solid waste exit tube 94 may extend from the juice extractor bottom end 48, so that gravity will help to urge the solid waste 76 into the solid waste exit tube 94. The solid waste exit tube 94 may be positioned proximate to the junction between the juice extractor bottom end 48 and the juice extractor second lateral side 52, so that the solid waste 76 can fall from the screen 78 into the solid waste exit tube 94.

A waste bin 94 may be fluidly couplable to the solid waste exit tube 94 to receive the solid waste 76. For example, the waste bin 94 may be positionable beneath a solid waste exit tube outlet 130 so that the solid waste 76 can fall from the solid waste exit tube 94 into the waste bin 94. The waste bin 94 may be removably positionable within the refrigerator door 14.

A waste bin recess 98 may extend into the refrigerator door 14. The waste bin recess 98 generally has a size that is complementary to a size of the waste bin 94 wherein the waste bin 94 is removably positionable within the waste bin recess 98. For example, the waste bin recess 98 may be positioned on the outer wall 18 of the refrigerator door 14, facilitating placement of the waste bin 94 within the waste bin recess 98 while the refrigerator door 14 is closed. The solid waste exit tube 94 extends into the waste bin recess 98 wherein the solid waste exit tube 94 is positioned above the waste bin 94 when the waste bin 94 is positioned in the waste bin recess 98. For example, the solid waste exit tube outlet 130 may be positioned within the waste bin recess 98. The waste bin 94 is configured to receive the solid waste 76 when the solid waste 76 exits the solid waste exit tube 94.

A waste bin access door 100 may be coupled to the refrigerator door 14. The waste bin access door 100 is selectively positionable over the waste bin recess 98. Accordingly, when the waste bin recess 98 is positioned on the outer wall 18 of the refrigerator door 14, the waste bin access door 100 is generally also positioned on the outer wall 18. The waste bin access door 100 is selectively openable to facilitate access to the waste bin recess 98. The waste bin access door 100 may be pivotably coupled to the refrigerator door 14 wherein the waste bin access door 100 is pivotable outwardly from the outer wall 18 of the refrigerator door 14 to facilitate access to the waste bin recess 98 and wherein the waste bin access door 100 is pivotable inwardly toward the outer wall 18 of the refrigerator door 14 to inhibit access to the waste bin recess 98. Alternatively, the waste bin access door 100 may be slidably coupled to the refrigerator door 14.

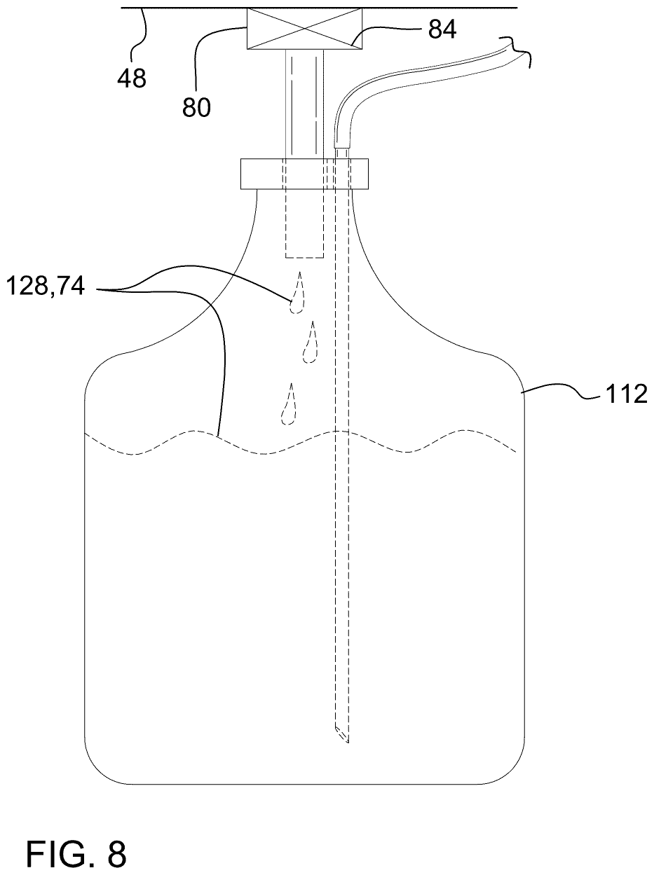

A container 112, such as the jug shown in FIG. 8, is fluidly coupled to the juice extractor 44. The juice 74 flows from the juice extractor 44 into the container 112. The container 112 is generally positioned within the refrigerator door interior space 22. The container 112 may be sealed wherein the container 112 is configured to inhibit the juice 74 from splashing from the container 112 into the refrigerator door interior space 22.

A juice dispenser alcove 114 may extend into the outer wall 18 of the refrigerator door 14. The juice dispenser alcove 114 is configured to receive a glass 132 wherein the juice dispenser alcove 114 is configured to facilitate filling the glass 132 with the juice 74. The juice dispenser alcove 114 may be spaced from the waste bin recess 98. For example, the juice dispenser alcove 114 may be positioned above the waste bin recess 98.

A nozzle 116 is fluidly coupled to the container 112. The nozzle 116 may extend outwardly from the refrigerator door interior space 22 into the juice dispenser alcove 114. The nozzle 116 is generally configured to be positioned above the glass 132 to release the juice 74 into the glass 132 when the glass 132 is positioned in the juice dispenser alcove 114. For example, the nozzle 116 may have a nozzle outlet 118 that is exposed within the juice dispenser alcove 114 wherein the nozzle outlet 118 is configured to be positioned above the glass 132 when the glass 132 is positioned in the juice dispenser alcove 114.

A pump 120 may be electrically coupled to the processor 42. The pump 120 is coupled to the container 112 and the nozzle 116. The pump 120 is actuatable to direct the juice 74 from the container 112 outwardly through the nozzle 116. The pump 120 may be positioned in the refrigerator door interior space 22, for example, proximate to the juice dispenser alcove 114.

A control panel 122 may be electrically coupled to the processor 42 wherein the control panel 122 is actuatable to selectively actuate the processor 42. For example, the control panel 122 may comprise a touch screen 124 that is positioned on the outer wall 18 of the refrigerator door 14. The touch screen 124 may be positioned proximate to the juice dispenser alcove 114 so that the touch screen 124 is convenient to manipulate once the user has positioned the glass 132 within the juice dispenser alcove 114. The touch screen 124 may include a plurality of virtual buttons 126. Each virtual button of the plurality of virtual buttons 126 may be actuatable to signal the processor 42 to actuate a respective one of the roller motor 72, the valve 84, the pump 120, and the gate motor 108.

In use, the juicing material 40 can be added to the hopper inner volume 38. The refrigerator door 14 may then be closed, and one of the plurality of virtual buttons 126 on the touch screen 124 of the control panel 122 may be manipulated to actuate the roller motor 72. The juicing material 40 will travel from the hopper 30 into the juice extractor 44, where the juicing material 40 will be squeezed and pressed to extract the juice 74 and separate the juice 74 from the solid waste 76. The juice 74 will flow downward through the juice drain 80 and into the container 112. The pump 120 may be actuated to direct the juice 74 from the container 112 outwardly through the nozzle 116 into the glass 132. The solid waste 76 will flow downward through the solid waste exit tube 94 into the waste bin 94. The waste bin 94 can be removed from the waste bin 94 alcove to dispose of the solid waste 76 from the juicing material 40.

The plurality of virtual buttons 126 may allow the user to select the particular volume of the juice 74 that the user wants to direct into the glass 132. The processor 42 may actuate the gate motor 108 to pivot the gate 102 to the gate closed position 106 once the motion sensor 110 detects that the threshold amount of the juicing material 40, which corresponds to the particular volume of the juice 74 desired by the user, has passed from the hopper 30 into the channel 86. The threshold amount of the juicing material 40 may also correspond to the amount of juicing material 40 which can pass through the juice extractor 44 at once. The processor 42 may actuate the gate motor 108 to pivot the gate 102 to the gate closed position 106 once the threshold amount of the juicing material 40 has passed the motion sensor 110 to inhibit the juice extractor 44 from is overfilled and becoming jammed or clogged with the juicing material 40.

At least some of the components of the juicing device 10 may be enclosed within the refrigerator door 14 or positioned within the refrigerator door interior space 22. To clean the juicing device 10, a cleaning fluid 128 may be added to the hopper 30. For example, the cleaning fluid 128 may comprise a mixture of water and dish soap. The cleaning fluid 128 may travel through the hopper 30 into the juice extractor 44, where the cleaning fluid 128 will flow over the pair of rollers 58 and into the container 112. The pump 120 may be actuated to direct the cleaning fluid 128 outwardly through the nozzle 116. The cleaning fluid 128 may also flow outwardly from the juice extractor 44 through the solid waste exit tube 94 and into the waste bin 94.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A juice dispensing system comprising:
a refrigerator having a refrigerator door;
a hopper being coupled to the refrigerator door, the hopper having a hopper inner volume, the hopper inner volume releasably retaining a juicing material;
a processor being positioned within the refrigerator door;
a juice extractor being coupled to the hopper wherein the juice extractor is configured to receive the juicing material from the hopper, the juice extractor being coupled to the refrigerator door, the juice extractor including:
a pair of rollers, each roller of the pair of rollers being rotatable;
a roller motor being electrically coupled to the processor, the roller motor being operably coupled to each roller of the pair of rollers wherein the roller motor is actuatable to rotate the each roller of the pair of rollers, the roller motor rotating the pair of rollers in opposing directions wherein the pair of rollers is configured to direct the juicing material downwardly between the pair of rollers when the juicing material contacts the pair of rollers, the pair of rollers being spaced from each other by a distance being configured to complement a size of the juicing material wherein the pair of rollers is configured to press the juicing material between the pair of rollers when the juicing material is directed downwardly between the pair of rollers to extract a juice from the juicing material;
a container being fluidly coupled to the juice extractor wherein the juice flows from the juice extractor into the container;
a juice dispenser alcove extending into the refrigerator door, the juice dispenser alcove being configured to receive a glass wherein the juice dispenser alcove is configured to facilitate filling the glass with the juice;
a nozzle being fluidly coupled to the container, the nozzle extending into the juice dispenser alcove wherein the nozzle is configured to be positionable above the glass to release the juice into the glass; and
a pump being electrically coupled to the processor, the pump being coupled to the container and the nozzle, the pump being actuatable to direct the juice from the container outwardly through the nozzle.

2. The juice dispensing system of claim 1, the pair of rollers further comprising:
a first roller being positioned proximate to a juice extractor first lateral side of the juice extractor, the first roller being parallel to the juice extractor first lateral side; and
a second roller being parallel to the first roller.

3. The juice dispensing system of claim 2, the first roller further comprising:
a first roller outer surface; and
a first roller blade being coupled to and extending outwardly from the first roller outer surface, the first roller blade being sharpened wherein the first roller blade is configured to slice the juicing material when the juicing material contacts the first roller.

4. The juice dispensing system of claim 3, wherein the first roller blade is coextensive with a length of the first roller.

5. The juice dispensing system of claim 2, the second roller further comprising:
a second roller outer surface; and
a second roller blade being coupled to and extending outwardly from the second roller outer surface, the second roller blade being sharpened wherein the second roller blade is configured to slice the juicing material when the juicing material contact the second roller.

6. The juice dispensing system of claim 5, wherein the second roller blade is coextensive with a length of the second roller.

7. The juice dispensing system of claim 1, the pair of rollers further comprising:
a first roller extending from a juice extractor first lateral side of the juice extractor to a juice extractor second lateral side of the juice extractor wherein the first roller is perpendicular to the juice extractor first lateral side; and
a second roller being positioned beneath the first roller, the second roller being parallel to the first roller.

8. The juice dispensing system of claim 7, the first roller further comprising:
a first roller outer surface; and
a first roller blade being coupled to and extending outwardly from the first roller outer surface, the first roller blade being sharpened wherein the first roller blade is configured to slice the juicing material when the juicing material contacts the first roller.

9. The juice dispensing system of claim 7, the second roller further comprising:
a second roller outer surface; and
a second roller blade being coupled to and extending outwardly from the second roller outer surface, the second roller blade being sharpened wherein the second roller blade is configured to slice the juicing material when the juicing material contacts the second roller.

10. The juice dispensing system of claim 1, further comprising a cutting tool being positioned between the hopper and the juice extractor wherein the cutting tool is configured to slice the juicing material as the juicing material moves from the hopper inner volume to the juice extractor to facilitate the juice extractor in extracting the juice from the juicing material.

11. The juice dispensing system of claim 1, further comprising:
a solid waste exit tube being fluidly coupled to the juice extractor wherein the solid waste exit tube is configured to facilitate removal of a solid waste from the juice extractor, the solid waste exit tube extending downwardly from the juice extractor; and
a waste bin being fluidly coupled to the solid waste exit tube to receive the solid waste, the waste bin being removably positionable within the refrigerator door.

12. The juice dispensing system of claim 11, further comprising a waste bin recess extending into the refrigerator door, the waste bin recess having a size being complementary to a size of the waste bin wherein the waste bin is removably positionable within the waste bin recess, the solid waste exit tube extending into the waste bin recess wherein the solid waste exit tube is positioned above the waste bin when the waste bin is positioned in the waste bin recess and wherein the waste bin is configured to receive the solid waste when the solid waste exits the solid waste exit tube.

13. The juice dispensing system of claim 1, further comprising:
a channel coupling the hopper to the juice extractor wherein the juicing material moves through the channel from the hopper to the juice extractor;
a gate being coupled to the channel, the gate being positioned adjacent to the hopper, the gate being pivotably coupled to the channel wherein the gate is pivotable between a gate open position and a gate closed position, the gate extending downwardly along the channel when the gate is in the gate open position wherein the gate is configured to facilitate the juicing material in exiting the hopper inner volume through the channel, the gate extending across the channel when the gate is in the gate closed position wherein the gate is configured to inhibit the juicing material from exiting the hopper inner volume through the channel; and
a gate motor being electrically coupled to the processor, the gate motor being operably coupled to the gate wherein the gate motor is actuatable to selectively pivot the gate between the gate open position and the gate closed position.

14. The juice dispensing system of claim 13, further comprising a motion sensor being coupled to the channel, the motion sensor being electrically coupled to the processor, the motion sensor being positioned adjacent to the gate wherein the motion sensor is configured to detect movement of the juicing material through the channel when the gate is in the gate open position, the processor actuating the gate motor to pivot the gate to the gate closed position when a threshold amount of the juicing material has passed from the hopper into the channel.

15. A juice dispensing system comprising:
a refrigerator having a refrigerator door, the refrigerator door having an inner wall, an outer wall, and a peripheral wall being coupled to and extending between the inner wall and the outer wall to define a refrigerator door interior space;
a transformer being positioned within the refrigerator, the transformer being electrically coupled to a power input, the power input being configured to be electrically couplable to an extrinsic power source wherein the power input is configured to transfer power from the extrinsic power source to the transformer, the power input being a power cord extending from the refrigerator;
a hopper being coupled to the refrigerator door, the hopper being positioned in the refrigerator door interior space, the hopper having a hopper top end, a hopper bottom end, and a hopper lateral wall being coupled to and extending between the hopper top end and the hopper bottom end to define a hopper inner volume, the hopper inner volume releasably retaining a juicing material, the hopper top end being open to facilitate access to the hopper inner volume;
a processor being electrically coupled to the transformer, the processor being positioned in the refrigerator door interior space;
a juice extractor being coupled to the hopper wherein the juice extractor is configured to receive the juicing material from the hopper inner volume, the juice extractor being positioned in the refrigerator door interior space, the juice extractor including:
a juice extractor top end being positioned proximate to the hopper;
a juice extractor bottom end being spaced from the juice extractor top end;
a juice extractor first lateral side being coupled to and extending between the juice extractor top end and the juice extractor bottom end;
a juice extractor second lateral side being spaced from the juice extractor first lateral side, the juice extractor second lateral side being coupled to and extending between the juice extractor top end and the juice extractor bottom end;
a juice extractor front side being coupled to and extending between the juice extractor top end and the juice extractor bottom end, the juice extractor front side being perpendicular to the juice extractor first lateral side and the juice extractor second lateral side;
a juice extractor back side being spaced from the juice extractor front side, the juice extractor back side being parallel to the juice extractor front side;
a pair of rollers being positioned proximate to the juice extractor top end, each roller of the pair of rollers being rotatable, the pair of rollers extending between the juice extractor front side and the juice extractor back side wherein the pair of rollers is parallel to the juice extractor first lateral side and the juice extractor second lateral side, the pair of rollers including:
a first roller being positioned proximate to the juice extractor first lateral side;
a second roller being positioned proximate to the juice extractor second lateral side;
a roller motor being electrically coupled to the processor, the roller motor being operably coupled to each roller of the pair of rollers wherein the roller motor is actuatable to rotate the each roller of the pair of rollers, the roller motor rotating the pair of rollers in opposing directions wherein the pair of rollers is configured to direct the juicing material downwardly between the pair of rollers when the juicing material contacts the pair of rollers, the roller motor rotating the first roller in a first direction, the roller motor rotating the second roller in a second direction, the pair of rollers being spaced from each other by a distance being configured to complement a size of the juicing material wherein the pair of rollers is configured to press the juicing material between the pair of rollers when the juicing material is directed downwardly between the pair of rollers to extract a juice from the juicing material, the roller motor rotating the pair of rollers in opposing directions wherein the pair of rollers is configured to urge a solid waste from the juicing material downward toward the juice extractor bottom end after the juicing material contacts each roller of the pair of rollers;
a screen being positioned beneath the pair of rollers, the screen being coupled to the juice extractor first lateral side, the screen being angled to extend outwardly from the juice extractor first lateral side toward the juice extractor second lateral side and to extend downwardly toward the juice extractor bottom end, the screen being foraminous wherein the screen is configured to facilitate the juice in draining through the screen, the screen being spaced from the juice extractor second lateral side wherein the screen is configured to facilitate the solid waste in moving toward a junction between the juice extractor bottom end and the juice extractor second lateral side;
a juice drain extending through the juice extractor bottom end for releasing the juice from the juice extractor, the juice drain being centrally positioned between the juice extractor first lateral side and the juice extractor second lateral side;
a funnel being coupled to the juice drain, the funnel extending upwardly from the juice drain toward the screen wherein the funnel is configured to direct the juice into the juice drain; and
a valve being coupled to the juice drain, the valve being movable between a valve open position and a valve closed position wherein the juice flows outwardly through the juice drain when the valve is in the valve open position and wherein the juice is inhibited from flowing outwardly through the juice drain when the valve is in the valve closed position, the valve being electrically coupled to the processor wherein the processor is configured to move the valve between the valve open position and the valve closed position;
a channel coupling the hopper to the juice extractor, the channel extending downwardly from the hopper bottom end to the juice extractor top end wherein the juicing material moves through the channel from the hopper to the juice extractor;
a cutting tool being positioned in the channel, the cutting tool extending across the channel wherein the cutting tool is configured to slice the juicing material as the juicing material moves from the hopper inner volume to the juice extractor, the cutting tool including:
a rod being coupled to and extending across the channel, the rod being perpendicular to the channel; and
a plurality of disks being coupled to the rod, the plurality of disks being sharpened wherein the plurality of disks is configured to slice the juicing material before the juicing material reaches the pair of rollers of the juice extractor whereby the cutting tool is configured to facilitate the juice extractor in extracting the juice from the juicing material;
a solid waste exit tube being fluidly coupled to the juice extractor wherein the solid waste exit tube is configured to facilitate removal of the solid waste from the juice extractor, the solid waste exit tube extending from the juice extractor bottom end, the solid waste exit tube being positioned proximate to the junction between the juice extractor bottom end and the juice extractor second lateral side;
a waste bin being fluidly coupled to the solid waste exit tube to receive the solid waste, the waste bin being removably positionable within the refrigerator door;
a waste bin recess extending into the refrigerator door, the waste bin recess being positioned on the outer wall of the refrigerator door, the waste bin recess having a size being complementary to a size of the waste bin wherein the waste bin is removably positionable within the waste bin recess, the solid waste exit tube extending into the waste bin recess wherein the solid waste exit tube is positioned above the waste bin when the waste bin is positioned in the waste bin recess and wherein the waste bin is configured to receive the solid waste when the solid waste exits the solid waste exit tube;
a waste bin access door being pivotably coupled to the outer wall of the refrigerator door, the waste bin access door being pivotable outwardly from the outer wall of the refrigerator door to facilitate access to the waste bin recess, the waste bin access door being pivotable inwardly toward the outer wall of the refrigerator door to inhibit access to the waste bin recess;
a gate being coupled to the channel, the gate being positioned adjacent to the hopper bottom end, the gate being pivotably coupled to the channel wherein the gate is pivotable between a gate open position and a gate closed position, the gate extending downwardly along the channel when the gate is in the gate open position wherein the gate is configured to facilitate the juicing material in exiting the hopper inner volume through the channel, the gate extending across the channel when the gate is in the gate closed position wherein the gate is configured to inhibit the juicing material from exiting the hopper inner volume through the channel;
a gate motor being electrically coupled to the processor, the gate motor being operably coupled to the gate wherein the gate motor is actuatable to selectively pivot the gate between the gate open position and the gate closed position;
a motion sensor being coupled to the channel, the motion sensor being electrically coupled to the processor, the motion sensor being positioned adjacent to the gate wherein the motion sensor is configured to detect movement of the juicing material through the channel when the gate is in the gate open position, the processor actuating the gate motor to pivot the gate to the gate closed position when a threshold amount of the juicing material has passed from the hopper into the channel;
a container being fluidly coupled to the juice extractor wherein the juice flows from the juice extractor into the container, the container being positioned within the refrigerator door interior space;
a juice dispenser alcove extending into the outer wall of the refrigerator door, the juice dispenser alcove being configured to receive a glass wherein the juice dispenser alcove is configured to facilitate filling the glass with the juice, the juice dispenser alcove being positioned above the waste bin recess, the juice dispenser alcove being spaced from the waste bin recess;
a nozzle being fluidly coupled to the container, the nozzle extending outwardly from the refrigerator door interior space into the juice dispenser alcove wherein the nozzle is configured to be positioned above the glass to release the juice into the glass when the glass is positioned in the juice dispenser alcove;
a pump being electrically coupled to the processor, the pump being coupled to the container and the nozzle, the pump being actuatable to direct the juice from the container outwardly through the nozzle, the pump being positioned in the refrigerator door interior space proximate to the juice dispenser alcove;
a control panel being electrically coupled to the processor wherein the control panel is actuatable to selectively actuate the processor, the control panel comprising a touch screen being positioned on the outer wall of the refrigerator door proximate to the juice dispenser alcove, the touch screen including a plurality of virtual buttons wherein each virtual button of the plurality of virtual buttons is actuatable to signal the processor to actuate a respective one of the roller motor, the valve, the pump, and the gate motor.
